(19) United States
(12) Patent Application Publication
(10) Pub. No.: US 2026/0330734 A1
(43) Pub. Date: Oct. 22, 2026

(54) SYSTEM AND PROCESS FOR ANIMATION

(71) Applicant: FIGABYTE SOLUTIONS d.o.o., Zagreb (HR)

(72) Inventor: Josip HALASZ, Zagreb (HR)

(21) Appl. No.: 19/653,339

(22) Filed: Apr. 21, 2026

Related U.S. Application Data
(60) Provisional application No. 63/792,625, filed on Apr. 22, 2025.

(51) Int. Cl. G06T 13/00; G06F 3/04845

(52) U.S. Cl. CPC G06T 13/00; G06F 3/04845

(57) ABSTRACT

A method and system for creating animations is disclosed. A user obtains visual content to be used as a background component and visual content to be used as an animated component. The user creates animations by manipulating the animated component in relation to the background component, simultaneously with the background component’s playback. A manual user input is used for a manipulation resulting in changing animated component’s parameters such as position, scale, width scale, height scale, skew and rotation in relation to the background component’s time. These animation parameters are recorded. A new video is created from the images of the background component and the animated component, such that the animated component is overlaid on the background component using the recorded animation parameters relating to times of the images. The newly created video can be saved, shared, discarded, or further edited.

### CROSS-REFERENCE TO RELATED APPLICATION AND CLAIM TO PRIORITY

The application claims the benefit of U.S. Provisional Patent Application Ser. No. 63/792,625 filed on Apr. 22, 2025, by Halasz, J., which is hereby incorporated herein by reference in its entirety and to which priority is claimed.

### BACKGROUND OF THE INVENTION

### 1. Field of the Invention

The invention relates generally to editing video. More particularly, the invention relates to a system and process for creating animations.

### 2. Description of the Related Art

With more video being produced every day by professionals, as well as by the general public, the need to create animations is increasing. There exists a growing number of video editing applications, both for professional and general public use. The ability to create complex, arbitrary animations seem to be limited to professional applications, where applications for general public sometimes provide limited sets of template animations.

On more sophisticated video editing platforms more complex animations can be achieved in the following way: For example, a user can define different animation parameters (such as, for example, position, scale, and rotation of the animation object in relation to the background) for certain different frames of the video. This creates an animation effect where animation parameters, such as position, are interpolated between mentioned different frames and thereby creating, in this case, a motion animation. In the case of a more complex animation, it can be a very laborious process of defining the animation parameters for many different individually selected frames. Because of the above, and the fact that this feature is usually available on commercial video editing platforms which require knowledge to operate, creating complex animations is out of reach of the general public.

### SUMMARY OF THE INVENTION

An object of the present invention is to create user friendly animation tool. Systems and methods are disclosed that enable features of animating position, scale, rotation, etc. where a user, responsive to his manual input, manipulates the animated component on the screen in relation to background video and simultaneously with background video playback, a new video is created that corresponds to the effect of the animated component being overlaid on the background video as was the case when the user was manipulating the animated component on the screen in relation to the background video and simultaneously with the background video playback.

By utilizing the described method an application can be developed that makes creating animations very user friendly and thereby within reach of the general public. For people more skilled in animation it provides potentially significant time saving. Unlike other methods that provide static process of defining animation parameters, the presented method(s) herein provides a dynamic process of defining animation parameters.

Other methods that provide static process of defining animation parameters are more time and labor consuming in a general case than the presented method with its dynamic process of defining animation parameters. The present method provides, unlike any other method, creating animations using dynamic user input.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the of the invention. In such drawings:

FIG. 1 illustrates an overview of a system for implementing a system and method according to an exemplary embodiment of the present invention;

FIG. 2 depicts the sub steps involved with step 300 (Record a Sequence);

FIG. 3A-D illustrate an example an input logic for a method according to the exemplary embodiment of the present invention;

FIG. 4A-4D illustrate a second example an input logic for the method of the exemplary embodiment of the present invention;

FIG. 5A-5D illustrate a third example an input logic for the present method;

FIG. 6A-6C, 7A-7C and 8A-8C each illustrate examples of multiple sequence logic for the present method; and

FIG. 9 is a schematic of a hardware portion of device 12 used in the method according to the exemplary embodiment of the present invention.

### DETAILED DESCRIPTION OF EXEMPLARY EMBODIMENTS

Reference will now be made in detail to the exemplary embodiments and exemplary methods as illustrated in the accompanying drawings, in which similar reference characters designate similar or corresponding parts throughout the drawings. It should be noted, however, that the invention in its broader aspects is not necessarily limited to the specific details, representative materials and methods, and illustrative examples shown and described in connection with the exemplary embodiments and exemplary methods.

The foregoing descriptions, formulations, diagrams, and figures are provided merely as illustrative examples, and they are not intended to require or imply that the steps of the various embodiments must be performed in the order presented or that the components of the invention be arranged in the same manner as presented. The steps in the foregoing descriptions and illustrations may be performed in any order, and components of the invention may be arranged in other ways. Words such as “then,” “next,” etc., are not intended to limit the order of the steps or the arrangement of components; these words are used merely to guide the reader through the description of the invention. Although descriptions and illustrations may describe the operations as a sequential process, one or more of the operations can be performed in parallel or concurrently, or one or more components may be arranged in parallel or sequentially. In addition, the order of the operations may be rearranged.

This description of exemplary embodiments is intended to be read in connection with the accompanying drawings, which are to be considered part of the entire written description. In the description, relative terms such as "horizontal," "vertical," "front," "rear," “upper”, “lower”, "top" and "bottom" as well as derivatives thereof (e.g., "horizontally," "downwardly," "upwardly," etc.) should be construed to refer to the orientation as then described or as shown in the drawing figure under discussion and to the orientation relative to a vehicle body. These relative terms are for convenience of description and normally are not intended to require a particular orientation. Terms concerning attachments, coupling and the like, such as "connected" and "interconnected," refer to a relationship wherein structures are secured or attached to one another either directly or indirectly through intervening structures, as well as both movable or rigid attachments or relationships, unless expressly described otherwise. The term "operatively connected" is such an attachment, coupling or connection that allows the pertinent structures to operate as intended by virtue of that relationship. The term “integral” (or “integrated”) relates to a part made as a single part, or a part made of separate components connected together. Additionally, the word “a” and “an” as used in the claims means “at least one” and the word “two” as used in the claims means “at least two”.

Moreover, in this disclosure the term “animated component” (noun) refers to a component that comprises any visual content that can be animated in relation to its background, such as an image, a video, a graphic artefact that has various properties and effects such as color(s), pattern(s), blur, drop shadow, glow, etc. The animation components may also be a type of a parameterized rig or a blend shape animation artefact. The animation components may also be a type of a text using, for example, a keypad, where the user’s finalized text is then used as an animated component. On the other hand, a user’s typing of a text in real time may be recorded constituting visual content to be used as an animation component. Similarly, the user’s typing of a text, in real time, simultaneously with the background component’s playback, may constitute visual content to be used as an animation component. The animation components may also be a type of drawing, using, for example, a finger or a stylus, where the user’s finalized drawing is then used as an animated component. On the other hand, a user’s drawing in real time may be recorded constituting visual content to be used as an animation component. Similarly, the user’s drawing, in real time, simultaneously with the background component’s playback, may constitute visual content to be used as an animation component. This disclosure is not limited to any particular type of an animated component.

In this disclosure the term “background component” (noun) refers to a component that comprises any visual content that can be used as a background in relation to which an animated component can be animated. It may be a component such as a video of any kind, an image of any kind, a colored background of a single color or multitude of colors, a transparent background, etc. This disclosure is not limited to any particular type of a background component nor is it limited to any property of the background component such as aspect ratio, pixel size or any other property. In this disclosure, for the sake of brevity and clarity, and in a non-limiting way, a term “background video” may be used instead of the term “background component”. When the term “background video playback” is used, it implies also the case when the background component is an image or a colored background, for example. In this case the image or a colored background is converted to a video that consists of frames that consist of the mentioned image or of the colored background. This conversion may be an actual one or it may be fictional in a way that the static image is displayed but that video time, video progress rate, and various playback rates are created through various time measuring tools and methods, the result of which is that the animation parameters are recorded in relation to the created time just like they would be if the background component was a video.

In this disclosure the term “playback” is used to describe the process of reproducing a video on a display unit either at normal (1x), slower than normal (<1x) or faster than normal (>1x) rate.

In this disclosure the term “to record” (verb) is used to describe a process of assigning (storing or recording in computer memory) animation parameters to certain particular temporal or frame-based positions of the background video. Assigning animation parameters in any other way, direct or indirect, to temporal or frame-based positions of the background video would not depart from the present disclosure. Other temporal or frame-based positions are also considered to have been assigned animation parameters if these are to be derived from animation parameters that have been recorded. For example, said parameters may be assigned to certain temporal or frame-based positions separated by a certain interval and the parameters for temporal or frame-based positions between those certain temporal or frame-based positions are interpolated from the parameters of those certain temporal or frame-based positions.

In this disclosure the term “recording” (noun) refers to stored animation parameters data.

In this disclosure the term “animation” (noun) refers to a film, video, or digital sequence of moving images.

In this disclosure the term “to animate” (verb) is used to describe the process of creating an animation from the background video and an animated component where frames of the created animation video are created by overlaying animated component over the background video.

In this disclosure the term “animation feature” (noun) is used to describe the video editing tool used for creating an animation from the background video and an animated component where frames of the created animation video are created by overlaying animated component over the background.

In this disclosure the term “animation parameters” (noun) is used to describe the configurable values that control how an animated element behaves, appears, and interacts with its environment during motion sequences. These include spatial parameters such as position, scale, width or height scale, skew and rotation that determine an element's physical relationship to its background; compositional parameters including opacity, blend modes, Z-index and masks that define how the element visually integrates with underlying content. Animation parameters may also encompass motion characteristics such as velocity, acceleration, and trajectory path. Animation parameters may also encompass effect parameters such as blur, drop shadow and glow. Animation parameters may also encompass any or all of the parameters that control a type of a parameterized rig or blend shape animation. This disclosure is not limited to any particular animation parameter or set of animation parameters. In this disclosure only a certain subset of animation parameters, such as position, scale and rotation may be used, for the sake of brevity and clarity, and in a non-limiting way, when describing certain embodiments of the presented method.

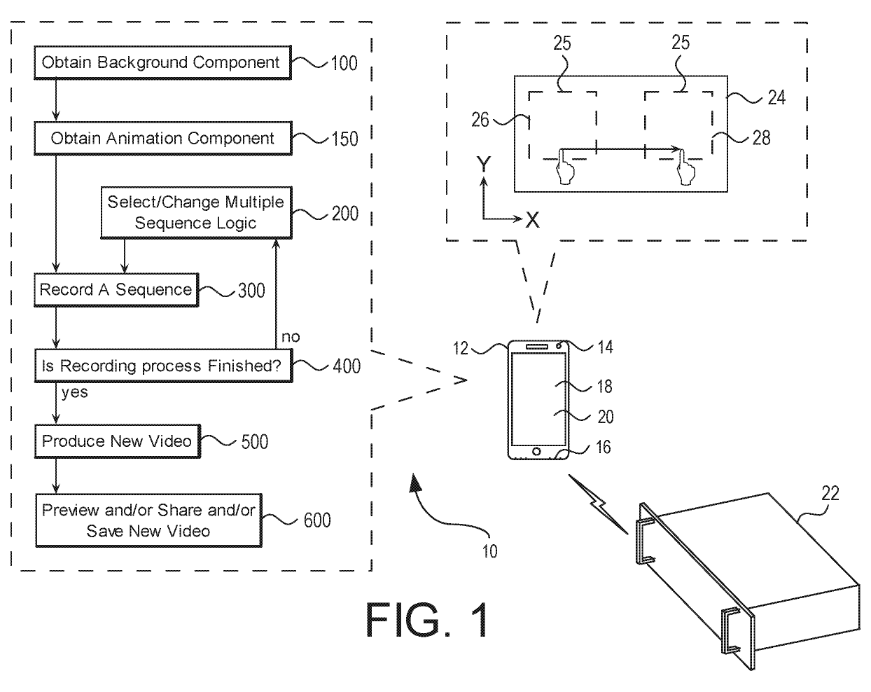

FIG. 1 illustrates an overview of a system 10 for implementing exemplary embodiments of the present invention. The system 10 comprises a device 12 (e.g., mobile phone, tablet, etc.) coupled to or including a camera(s) 14, microphone(s) 16, a server 22, a screen 18 and an input device 20. If in the following description steps illustrated in the drawings are referred to the device, due to computing complexity or other reason the server 22 can perform the steps without departing from the present disclosure. The device 12 may capture video data or an image that will be used as a background component 24 or an animated component 25 using camera(s) 14 or it may retrieve video data or an image that will be used as the background component 24 or the animated component 25 from different types of storages including storages that are accessed through a type of network. The device 12 may be used to select or establish any other type of data that will be used as the background component 24. For example, the user may select a single color from a palette of colors for background component 24. The user may also establish a morphological and/or chromatic pattern, or select a transparent background, etc. The device 12 may be used to select or establish any other type of data that will be used as the animated component 25. For example, the user could select a shape and establish its properties such as size, color, color pattern or gradient, blur, opacity, etc. The animated component could also be a type of a parameterized rigs or blend shape animation artefact. An example of the animated component’s first state (26) and animated component’s last state (28) are depicted. Even though illustrations depict the device 12 as a mobile phone/tablet device the present disclosure is not limited to any kind of device as long as it features the functionality required to perform the steps. If, for example, the video data or the image, that will be used as the background component 24 or the animated component 25, will be retrieved from the storage, the device may be not equipped with camera(s) 14 and microphone(s) 16. However graphical user interface, comprised of components such as a screen (18) and an input device (20), is necessary to perform some of the steps. Input devices 20 may be of different types such as touchscreen (input with finger or stylus pen), graphics tablet, touchpad, mouse, trackball, keyboard, a type of smart glasses, virtual or augmented reality devices (where eye direction and other properties are used as the user input), etc. Also, user inputs may be coming simultaneously from a plurality of same or different input devices. User inputs may be modified in a desirable way, set by user or otherwise, to achieve desired effect. Such modification may be in the form of smoothing user input. Modification may take place at the level of an input device or anywhere else in the method described herein. This disclosure is not limited to any particular types of modification.

The method may have the following embodiment. To obtain a background component (step 100) a user can retrieve a video or an image file from storage or from a video camera device or application. Or he can select or establish the background component (step 100). To obtain an animated component (step 150) a user can retrieve a video or an image file from storage or from a video camera device or application. Or the user can select or establish the animated component (step 150). The background component and the animated component are presented on the screen. The user can select input logic (step 304). The user chooses (step 306) a temporal or frame-based position of the video where to begin the recording sequence. The user can (step 308) define initial parameters of the animated component such as position, scale and rotation against the background component in accordance with input logic. The user can (step 310) choose a recording speed. The user can (step 312) start recording which starts the playback of the background video in a chosen speed. Simultaneously with the playback and using touchscreen input, the user can (step 314) manipulate the parameters of the animated component such as position, scale and rotation against the background video display in accordance with input logic, while at the same time the recording module records those parameters and assigns them to the temporal or frame-based positions of the background video. The user can (step 316) stop recording which stops the playback and finalizes the recording sequence. The user can (step 318) preview the recording. If the user is not (step 400) finished with the recording process he may repeat steps 200 through 400. If the user is (step 400) finished with the recording process he may execute (step 500) the video producing process which creates a new video which consists of frames derived by overlaying the animated component over the background component using the recorded animation parameters. The user may (in step 600) preview the produced video. The user may (step 600) share the produced video. The user also may (step 600) save the produced video.

While typically the background component’s and the animated component’s visual content will be different, it may also be the same.

Steps Obtain Background Component (step 100) and Obtain Animated Component (step 150) can be accomplished in any order or concurrently.

When the animated component is a video or other type of a time-based visual content which has a playback capability, simultaneously with the background component’s playback, the animated component may be played back starting from the beginning or from any other temporal or frame-based position in the animated component. Setting the temporal or frame-based position to be used as the starting point may be done automatically or manually.

Step 306 (Set Starting Point) may be omitted and the temporal or frame-based position in the background video where to begin the recording sequence may be implicitly set. For example, one such position may be the beginning of the video.

Step 308 (Set Initial Animation Parameters) may be omitted and the animation parameters may be implicitly set. Such implicit setting may, for example, be the result of some other user action or process, some automatic action or process, or combination thereof. The animation parameters may, for example, be initialized by an automatic method of content recognition such as face recognition, and be set to match the recognized face in order to aid the user in subsequent tracking of the face in order to blur the face or to cover the face with other type of animation component. In another example, an automatic method of content recognition and tracking such as face recognition may be utilized in order to blur or cover a face over a certain part of a video. If a user is not satisfied with the result of the automatic tracking, he may interrupt it, and start manually tracking, as described in this disclosure, using the animation parameters as found at the point of interruption as the initial animation parameters.

In this disclosure term Input logic refers to the animation parameters that can be manipulated and how user input is interpreted to manipulate them. The user input may be used to change all possible parameters, or it may be limited to changing only a subset of the possible parameters, not limited to any particular subset of parameters. It may interpret input on different areas of the screen in a different way.

When obtaining the visual content data to be used as a background component, it will usually be positioned and sized in the desirable way which will usually be such that it fits the display area, i.e. being as large as possible within the constraints of the display. A different sizing and positioning may be accomplished either automatically or manually. The sizing may be such that it is smaller than the size to fit the screen in order to improve manipulation of the animated component when it is partially or completely outside the bounds of the background component and/or the positioning may be such that it is not centered on the display in order to improve manipulation of the animated component when it is partially or completely outside one side of the background component. The sizing may be such that it is larger than the size to fit the screen in order to improve precision of the manipulation of the animated component over a certain area of the background component.

Steps 400 and 200 may be omitted in an exemplary embodiment where multiple sequence recording is not enabled.

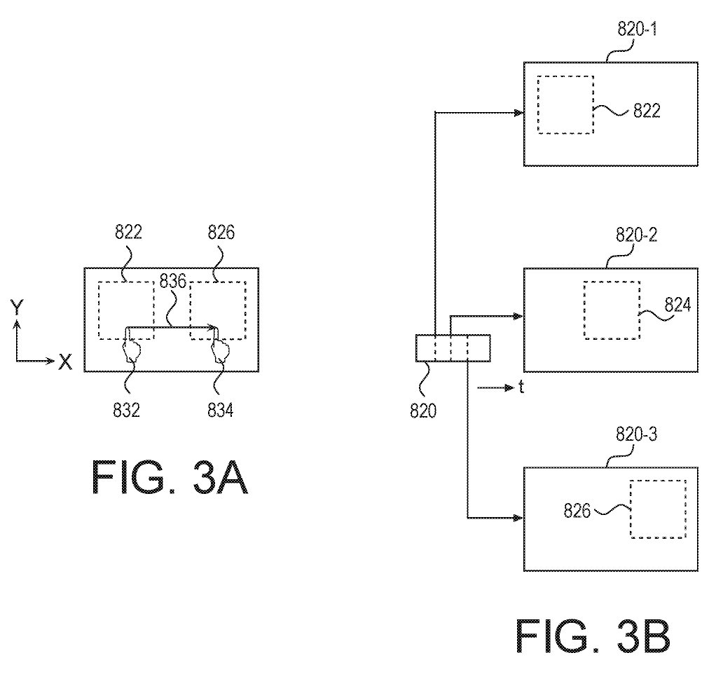

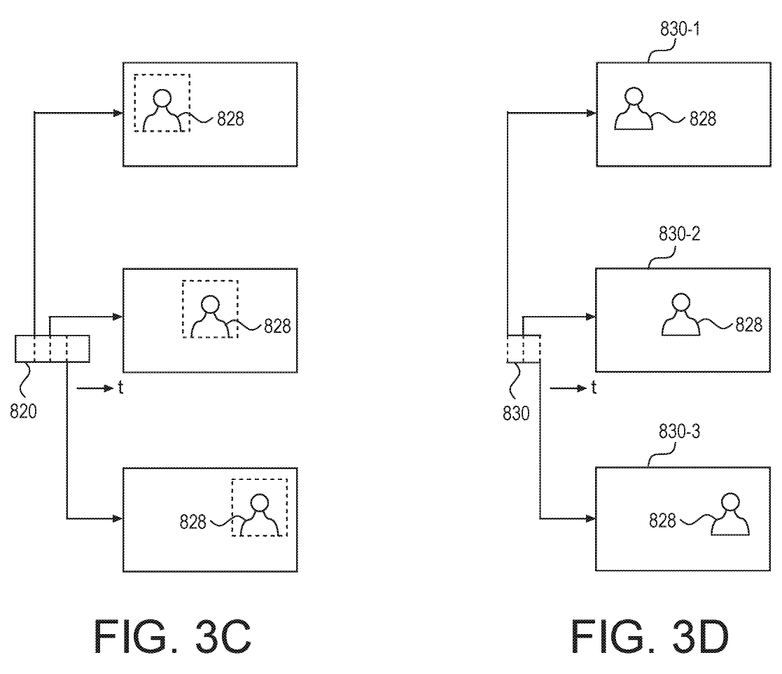

Examples of some practical input logics are presented on FIGS. 3A-D, 4A-D, 5A-D but this disclosure is not limited to those. Examples illustrate single and dual input of same type (finger on a touchscreen). This disclosure is not limited to any types of inputs nor their number or combinations of types and numbers.

FIGS. 3A-D illustrate an example of an input logic that allows only the position of the animated component to be manipulated in order to create position animation. FIG. 3A illustrates a single drag input from left to right i.e. in the positive x direction. The beginning of the drag input 832 determines the animated component first parameters 822, the continuous drag input 836 creates a plurality of animated component intermediate parameters 824 and the end of the drag input 834 determines the animated component last parameters 826. In order to allow only for the position animation, the input logic may be such that a two-finger input is interpreted as a single input of their center-weighted position. FIG. 3B illustrates the relation between the animated component first parameters 822 that are assigned to the first background video frame 820-1 that is associated with the first time, one of the animated component intermediate parameters 824 that are assigned to the second background video frame 820-2 that is associated with the second time and the animated component last parameters 826 that are assigned to the third background video frame 820-3 that is associated with the third time. FIG. 3C illustrates how such drag input can be used to animate an image of a person 828 over a monotonous background 820 creating its movement from left to right i.e. in the positive x direction. FIG. 3D illustrates the first 830-1, the intermediate 830-2 and the last 830-3 frame of the produced video 830 that has the said person 828 moving from left to right.

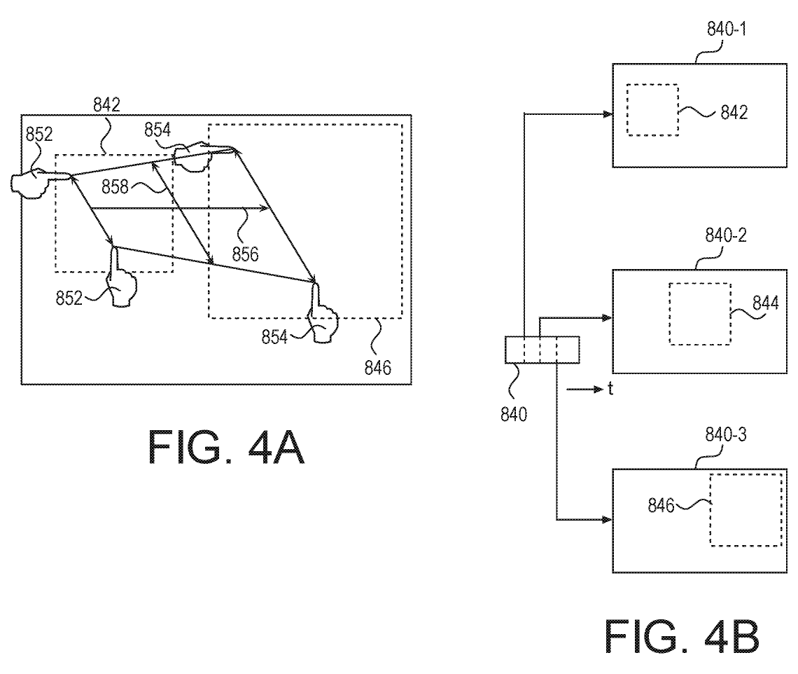

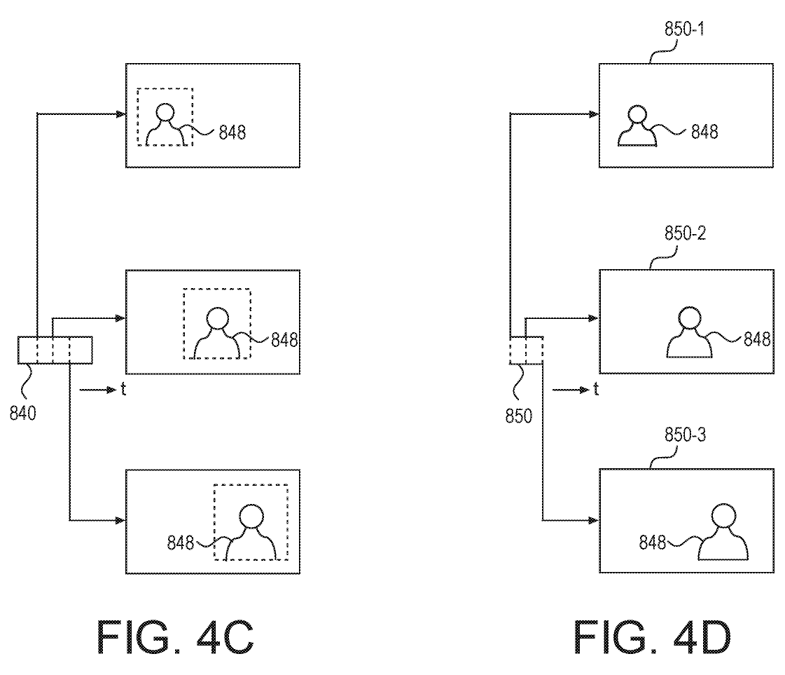

FIGS. 4A-D illustrate an example of an input logic such that a drag input on the animated component area is translated to movement of the animated component thereby producing a position animation. A two-finger drag input is interpreted as a single input of their center-weighted position. A two-finger pinch input is translated to changing the scale of the animated component producing the scale animation. Simultaneous drag and pinch can produce simultaneous position and scale animation. FIG. 4A illustrates the two-finger drag and pinch input from left to right i.e., in the positive x direction and with increasing distance between two fingers. The beginning of the input 852 determines the animated component first parameters 842, the continuous drag 856 and pinch 858 input creates plurality of animated component intermediate parameters 844 and the end of the input 854 determines the animated component last parameters 846. FIG. 4B illustrates the relation between the animated component first parameters 842 that are assigned to the first video frame 840-1 that is associated with the first time, one of the animated component intermediate parameters 844 that are assigned to the second video frame 840-2 that is associated with the second time and the animated component last parameters 846 that are assigned to the third video frame 840-3 that is associated with the third time. FIG. 4C illustrates how such position and scale animation can be used to animate an image of a person 848 over a monotonous background 840 creating its movement from left to right i.e. in the positive x direction and making it appear larger over time. FIG. 4D illustrates the first 850-1, intermediate 850-2 and last 850-3 frame of the produced video 850 that has the said person 848 moving from left to right and appearing larger over time.

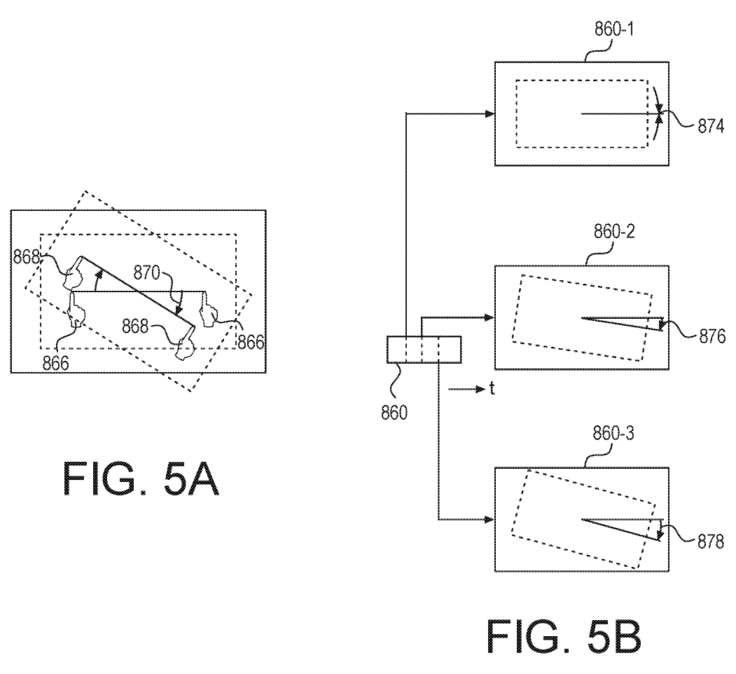

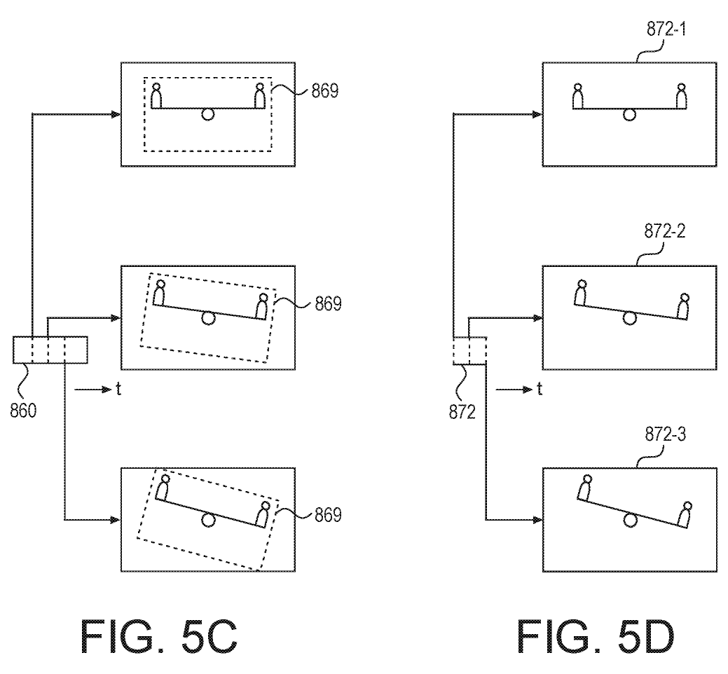

FIGS. 5A-D illustrate an example of an input logic such that a two-finger rotational input is translated to rotational movement of the animated component against the static background component thereby eventually producing a rotational animation. FIG. 5A illustrates a two-finger rotational input in the clockwise direction. The beginning of the input 866 determines the first rotational angle 874 (in the example it is arbitrarily set equal to zero), the continuous rotational input 870 creates plurality of intermediate rotational angles 876 and the end of the input 868 determines the last rotational angle 878. FIG. 5B illustrates the first rotational angle 874 that is assigned to the first video frame 860-1 that is associated with the first time, one of the intermediate rotational angles 876 that is assigned to the second video frame 860-2 that is associated with the second time and the last rotational angle 878 that is assigned to the third video frame 860-3 that is associated with the third time.

FIG. 5C illustrates how such rotational animation can be used to animate an image of a teeter totter device 869 over a monotonous background 860 creating its rotational movement in the clockwise direction. FIG. 4D illustrates the first 872-1, intermediate 872-2 and the last 872-3 frame of the produced video 872 that has the said teeter totter device 869 rotating in the clockwise direction.

In the examples presented in FIG. 3D, 4D and 5D, the produced videos, 830, 850 and 872 respectively, are produced only for the temporal or frame-based positions of the background component that have assigned animation parameters, i.e. the portion of the background component where there is a recording. In the example presented in FIG. 5D the produced video 872 starts with the first frame 872-1 and ends with the last frame 872-3. These frames correspond to the first frame 860-1, the frame where the recording starts, and the last frame 860-3, the frame where the recording ends, of the background component. The produced video may also be produced for temporal or frame-based positions of the background component other than presented in FIG. 3D, 4D and 5D, i.e. other than only the ones that have a recording. The produced video may be produced for some positions that have a recording, some positions that don’t or a combination thereof. This disclosure is not limited to any particular portion or temporal or frame-based positions of the background component that will be used for the produced video.

For example, the produced video may be produced for temporal or frame-based positions starting from the beginning of the background component and until the end of the background component. In this case for temporal or frame-based positions of the background component where there is no recording the animation component may not be overlaid on the background component making the produced video where the animated component is not there from the beginning of the video, it appears at the temporal or frame-based position of the beginning of the recording and then it disappears at the temporal or frame-based position of the end of the recording. In the said case for temporal or frame-based positions of the background component where there is no recording the animation component may, on the other hand, be overlaid using the parameters extrapolated form the recorded parameters. One type of extrapolation may be to have the parameters assigned the same value as the parameters assigned to the closest temporal or frame-based positions of the background component where there a recording making the produced video where the animated component is there from the beginning of the video until, and including, the temporal or frame-based position of the beginning of the recording having the same parameters as the recorded parameters at the beginning of the recording and from the temporal or frame-based position of the end of the recording the animated component maintains the same parameters as the recorded parameters at the end of the recording until the end of the produced video. This disclosure is not limited to any type of extrapolation.

In case where the animated component is a type of a parameterized rigs or blend shape animation artefact the animation parameters may be controlled, for example, using sliders where a slider controls an expression of an element, such as eyes, in a parameterized rig such as a face or it controls a basic emotional expression parameter, such as happiness, in a blend shape artefact such as a face.

FIG. 1 illustrates step 200 Select/change multiple sequence logic positioned after step 400 in the case that user is not finished with recording process and before user records the next sequence. Alternatively, the step 200 may be positioned after step 300 in case the new recorded sequence is not the first recorded sequence or it may be positioned before the step 300. Alternatively, the step 200 may be placed outside of the recording loop (i.e., the repetitive process of recording multiple sequences) if a user is not allowed to change multiple sequence logic for each new recording sequence. Alternatively, the step 200 may not even be presented to the user, i.e. multiple sequence logic may be preset and not available for selection or change by the user. Alternatively, the process may be constructed without steps 400 and 200 to create a process where only one sequence can be recorded and thereafter a new video produced. Additionally, selecting or changing multiple sequence logic may be enabled at any point of the overall recording process and be applicable for all recording sequences or any particular recording sequence or set of recording sequences.

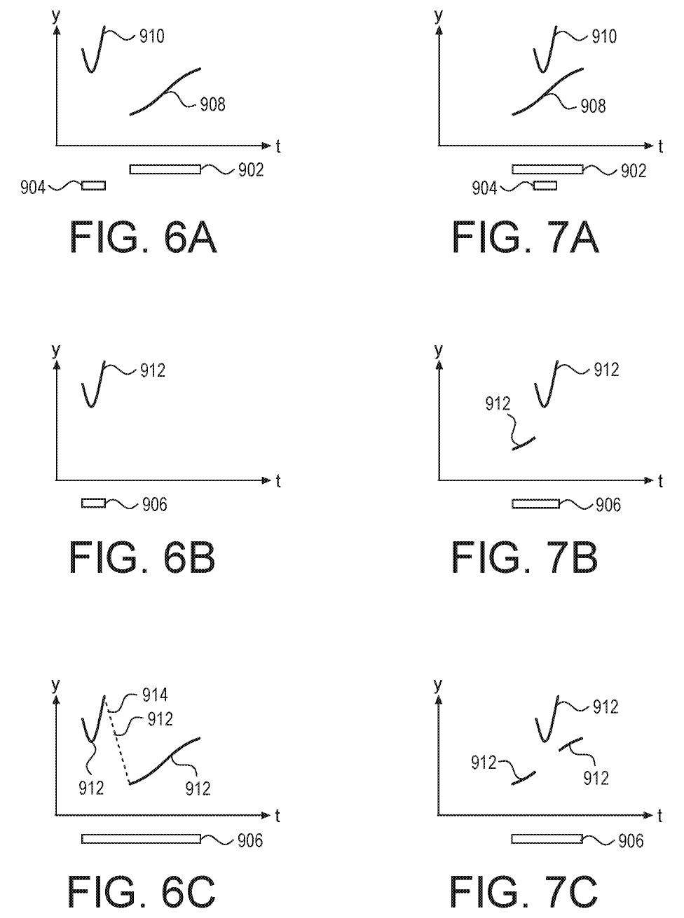

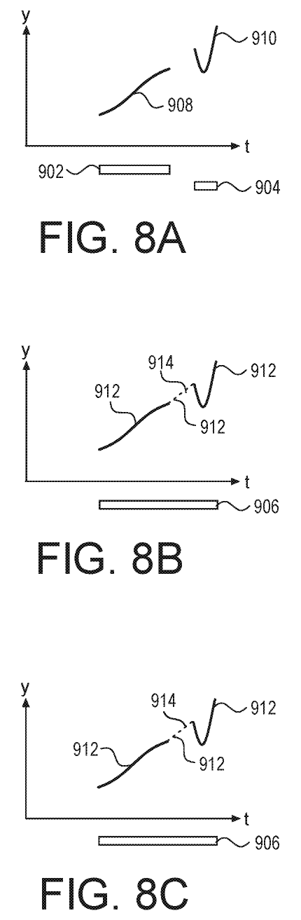

Examples of some multiple sequence logics are presented on FIGS. 6A-C, 7A-C and 8A-C but this disclosure is not limited only to those.

FIGS. 6A-C, 7A-C and 8A-C illustrate examples of multiple sequence logics on a simple case of a drag input in direction of y axis only which is plotted on the vertical axis against the background video time on the horizontal axis. Same can be applied to other types of input or their combinations. This disclosure is not limited to any particular types of input or combinations of those types.

FIGS. 6A, 7A and 8A illustrate a previous recording sequence 902 and a subsequent recording sequence 904 depicted versus the background video time as well as their respective animation parameters (908 and 910) for three different recording patterns. The previous recording sequence 902 is the sequence that the user has made, during the repetitive process of recording multiple sequences, prior to the subsequent recording sequence 904, irrespective of the background video time.

The previous recording sequence 902 may, for the purposes of this disclosure, be the first recording sequence made or it may be a recording resulting from a plurality of recording sequences made before the subsequent recording sequence 904 is made.

FIGS. 6B-C, 7B-C and 8B-C illustrate resulting recordings 906 and their resulting animation parameters 912 for two different cases of multiple sequence logic and three different recording patterns.

FIGS. 6B, 7B and 8B illustrate a multiple sequence logic such that when the subsequent recording sequence 904 is made the previous recording sequence 902 or part thereof is kept for times preceding the time where the subsequent recording sequence 904 is started. The previous recording sequence 902 or part thereof is deleted for times succeeding the time where the subsequent recording sequence 904 is started. The previous recording sequence 902 or part thereof which is kept is appended by the subsequent recording sequence 904.

FIGS. 6C, 7C and 8C illustrate a multiple sequence logic such that when the subsequent recording 904 sequence is made the previous recording sequence 902 or part thereof is kept for times preceding the time where the subsequent recording sequence 904 is started. The previous recording sequence 902 or part thereof is overwritten by the subsequent recording sequence 904 for any times where the previous and the subsequent recording are overlapping. The previous recording sequence 902 or part thereof is kept for times succeeding the time where the subsequent recording sequence 904 is stopped.

An example of another multiple sequence logic may be a logic such that when the subsequent recording sequence 904 is made the previous recording sequence 902 is deleted and the subsequent recording sequence 904 is kept.

An example of another multiple sequence logic may be a logic where each new recorded sequence is a new and separate recording sequence that is not influenced by nor influences other recording sequences and these recording sequences are used to produce a plurality of new videos in the step 500.

FIGS. 6C, 8B and 8C illustrate gaps that might occur in the resulting recording 906 in certain combinations of multiple sequence logic and recording patterns. Illustrated is an interpolated segment 914 where the animation parameters are interpolated linearly. The interpolation may be of a different type such as different types of nonlinear interpolation, Bezier curves, etc. This disclosure is not limited to any particular type of interpolation.

FIGS. 7B and 7C illustrate discontinuities in the resulting animation parameters 912 that might occur in certain combinations of multiple sequence logic and recording patterns. Discontinuities like these may or may not be the desired outcome. In order to help reduce the undesired discontinuities, and manage desired discontinuities, aides may be provided to the user when recording the subsequent recording sequence 904 by displaying animation parameters of the previous recording sequence 902. For example, setting the animation component’s animation parameters to those of the previous animation parameters 908 (which parameters can then be used as initial parameters for the subsequent recording sequence 904) when playing or skipping through the background video enables the user to avoid or manage the discontinuity at the start of the subsequent recording sequence 904. Also, displaying an animation component derived from the previous animation parameters 908 along with the active animation component that the user is manipulating during the recording of the subsequent recording sequence 904 the user can reduce or manage the discontinuity at the end of the subsequent recording sequence 904 by aligning the two animation components or setting the active animation component relative to the animation component derived from the previous animation parameters 908.

Automatic methods may be used to address the issue of the discontinuity that occurs from user input. Methods may be such as gradually changing the input parameters over a certain time interval, length of which may or may not be left to the users choosing. This disclosure is not limited to any particular method.

FIG. 1 illustrates the step 500 Produce new video after the step 400 is affirmatively answered but without departing from this disclosure video producing may, to the extent feasible, take place even before step 400 i.e., during the recording loop. It may take place during or between the recording of a recording sequence for parts or all of the recording. The logic of this video producing may favor producing video for parts of recording deemed less likely to change by the recording sequence or by the following recording sequences. Video producing may produce the video based on the recording as one video sequence. Alternatively, this video producing may be executed as a series of smaller video sequences effectively splitting the larger video sequence into smaller video sequences which could then be joined together. Such split producing may be favorable when a new recording sequence is made because some of these video sequences may not be affected with the new recording sequence and therefore would not require to be produced again.

Video producing may, to an extent feasible, take place at or near real time of user input. In such case the recording may be of a shorter-term character to the extent of how directly the animation parameters are being used to produce the video.

Video producing logic may be such to favorably utilize hardware’s processing capability such as capability of parallel processing. This disclosure is not limited to any particular video producing logic.

The produced video may be of various resolutions. The resolution may be the result of the resolution of the background component or it may be the resolution defined by the user or in some other way. This disclosure is not limited to any particular resolution or way to determine the resolution.

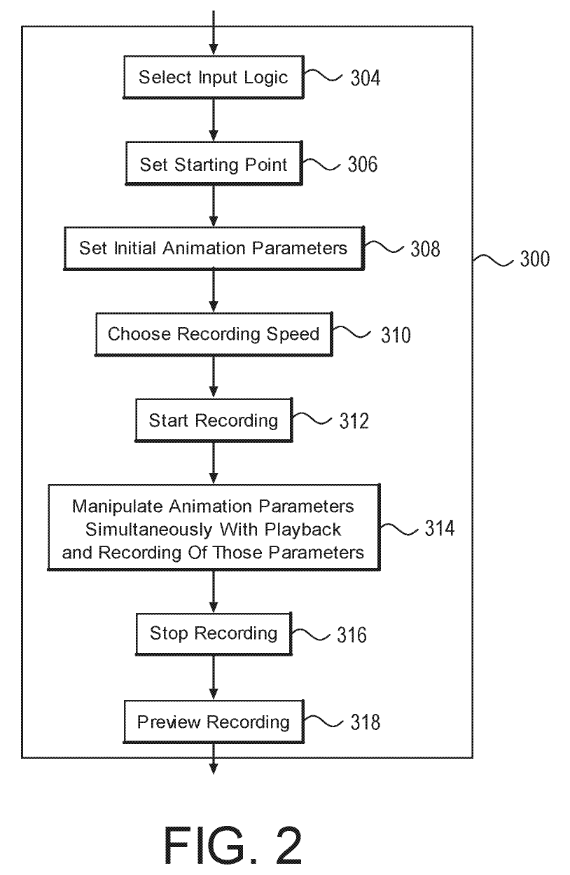

FIG. 2 depicts the step 318 (Preview Recording) at the end of step 300 Record a Sequence. Previewing recording may be, for example, achieved by playing the 100 Received video and simultaneously displaying the animation component derived from the resulting animation parameters 912. Or it may be achieved in some other way to present to the user how a produced video would appear without actually producing the video. For that purpose, a type of quick preview tool may be used.

FIG. 2 illustrates the step 304 Select input logic available in every recording of a sequence. Without departing from this disclosure, the step 304 may, for example, only be available at the beginning of the recording loop allowing only for a single input logic for a recording loop. Alternatively, the step 304 may not even be presented to the user, i.e. the input logic may be preset and not available for change by user.

Without departing from present disclosure, the recording process may be accomplished utilizing multiple parallel layers where each layer enables recording using certain particular input logic. By selecting a layer in which to record a sequence the user automatically selects particular input logic and records a sequence which affects only the recording in the selected layer i.e. is the subsequent recording sequence 904 to the previous recording sequence 902 (if any) in the selected layer. Recorded animation parameters in different layers may be superimposed to produce their combined effect on the produced video. An example of such layered recording process may be one where there are two layers each having the input logic as illustrated in FIGS. 3A-D in order to enable user to independently record vertical position animation and horizontal position animation. Another example of such layered recording process may be one where one layer has the input logic as illustrated in FIGS. 3A-D and the other layer has the input logic as illustrated in FIGS. 5A-D. Such process may for example enable the user to independently record position animation and rotation animation. Some particular layered processes might require establishing a hierarchy between layers because different orders in which the layers are applied might lead to different results. This disclosure is not limited to the examples above nor to any number of layers or input logic combinations, including combinations with different multiple sequence logic and hierarchies.

The process presented in this disclosure may further be expanded by allowing animating a multitude of animated components. One way may be to animate one component, produce a video and use the produced video as the background component for the next animated component. Another way may be to create a stacking context of sorts, a stacking context being a three-dimensional conceptual model that determines how animated components are rendered along the z-axis (depth) when they overlap in a two-dimensional layout. In this stacking context a multitude of stacking layers may be created each having a separate animated component and z-axis property determining the hierarchy of how its animated component will be overlaid as compared to animated components of other stacking layers. The stacking context may also be editable allowing the user to effectively change how animated components are rendered along the z-axis (depth) when they overlap in a two-dimensional layout. Each animated component is animated as described in this disclosure and the produced video has all of the animated components overlaid on the background component as determined by the stacking context.

Aides may be provided to the user to improve control of the animation parameters. For that purpose, aides such as grids or horizontal and vertical lines or references may be displayed. For example, the input logic as illustrated in FIGS. 5A-D may have an aid in the form of vertical and/or horizontal reference line(s) displayed centered over the background component and vertical and/or horizontal reference line(s) displayed centered over the animated component so that user can easily set rotation angle to 0 degrees when desired. Another aid may be in the form of numerically displaying the rotation angle of the animated component. Another aid may be to have the user input modified so that the rotation angle has a tendency to reach and maintain certain values. For example, the angle may have a tendency to reach and maintain value of 0 degrees. The tendency may appear to the user as if the angle has a tendency to “snap” to 0 degrees. For example, the input logic as illustrated in FIGS. 3A-D may have an aid in the form of vertical and/or horizontal grid lines displayed over the background video to help the user position the animated component over the background video. This disclosure is not limited to the above examples nor is it limited to any particular aides.

There may be constraints imposed on the animation parameters that can be achieved. For example, the animated component may not be allowed to position outside the bounds of the background component. Or it may be allowed to do so. Such constraints may or may not be left to the user’s choice and definition. This disclosure is not limited to the above examples nor is it limited to any particular constraints.

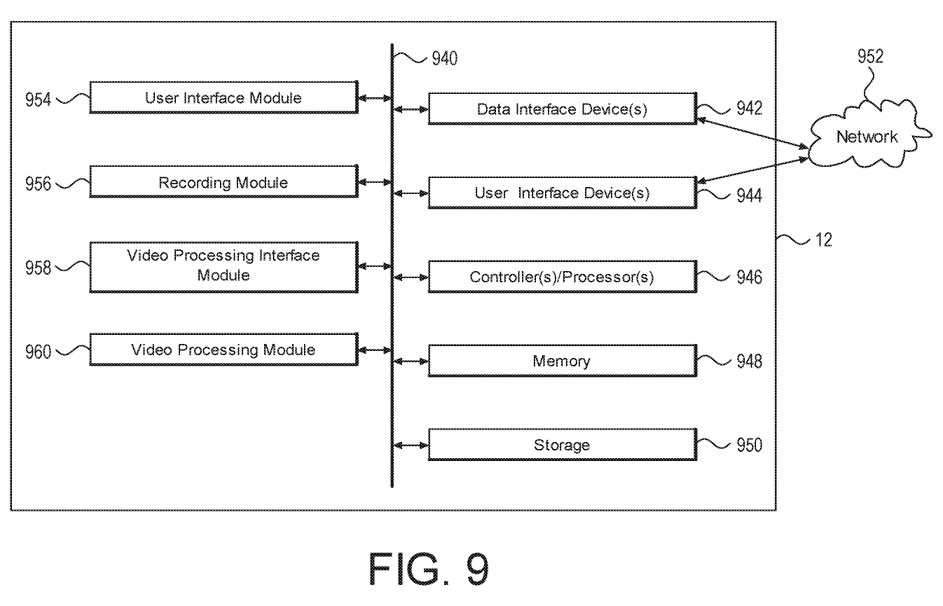

FIG. 9 illustrates block diagrams conceptually illustrating example components of a system 10 including one or more of a device 12 and a server 22. Whenever device 12 is illustrated and referred to, the server 22 could be illustrated and referred to instead and in place of without departing from present disclosure. Depending upon how the system is structured, some of the components illustrated in FIG. 9 as part of the device 12 or the server 22 may be included only in the device 12 or in the server 22, or may be distributed across multiple devices 12 and/or servers 22. Other components not illustrated may also be included in the device 12 and/or the server 22. In operation, the system 10 may include computer-readable and computer-executable instructions that reside in storage 950 on the device 12/server 22. Examples of electronic devices may include portable devices (e.g. smart phone, tablet, a camera (such as a 360° video camera), or the like), computers (e.g., a desktop, a laptop, a server or the like) or the like. The device 12/server 22 may also be a component of any of the abovementioned devices or systems.

As illustrated in FIG. 9, the device 12/server 22 may include an address/data bus 940 for conveying data among components of the device 12. Each component within the device 12/server 22 may also be directly connected to other components in addition to (or instead of) being connected to other components across the bus 940.

The device 12/server 22 may include one or more controllers/processors 946 comprising one-or-more central processing units (CPUs) for processing data and computer-readable instructions and a memory 948 for storing data and instructions. The memory 948 may include volatile random-access memory (RAM), non-volatile read only memory (ROM), non-volatile magneto resistive (MRAM) and/or other types of memory. The device 12/server 22 may also include a data storage component 950 for storing data and processor-executable instructions. The data storage component 950 may include one or more non-volatile storage types such as magnetic storage, optical storage, solid-state storage, etc. The device 12/server 22 may also be connected to a removable or external nonvolatile memory and/or storage (such as a removable memory card, memory key drive, networked storage, etc.) through the data interfaces devices 942.

The device 12/server 22 includes data 942 and user 944 interface device(s). A variety of components may be connected to the device 12/server 22 through data 942 and user 944 interface device(s), such as camera(s) 14 and microphone(s) 16. However, the disclosure is not limited thereto and the device 12/server 22 may not include an integrated camera or microphone. Thus, the camera(s) 14, microphone(s) 16 and/or other components may be integrated into the device 12 or may be separate without departing from the disclosure.

Data 942 and user 944 interface device(s) may be configured to operate with a network 952, for example a wireless local area network (WLAN) (such as WiFi), Bluetooth, zigbee and/or wireless networks, such as a Long Term Evolution (LTE) network, WiMAX network, 5G network, etc. The network 952 may include a local or private network or may include a wide network such as the internet. Devices may be connected to the network 952 through either wired or wireless connections.

Data 942 and user 944 interface device(s) may also include an interface for an external peripheral device connection such as universal serial bus (USB), Fire Wire, Thunderbolt, Ethernet port or other connection protocol that may connect to networks 952. Data 942 and user 944 interface device(s) may also include a connection to an antenna (not shown) to connect one or more networks 952 via a wireless local area network (WLAN) (such as WiFi) radio, Bluetooth, and/or wireless network radio, such as a radio capable of communication with a wireless communication network such as a Long Term Evolution (LTE) network, WiMAX network, 5G network, etc.

The device 12/server 22 further includes user interface module 954, recording module 956, video processing interface module 958 and video processing module 960 which may comprise processor-executable instructions stored in storage 950 to be executed by controller(s)/processor(s) 946 (e.g., software, firmware), hardware, or some combination thereof. For example, components of the user interface module 954, recording module 956, video processing interface module 958 or video processing module 960 may be part of a software application running in the foreground and/or background on the device 12/server 22. The user interface module 954, recording module 956, video processing interface module 958 and video processing module 960 may control the device 12/server 22 as discussed above, for example with regard to FIG. 1 and 2. Some or all of the controllers/modules of the user interface module 954, recording module 956, video processing interface module 958 or video processing module 960 may be executable instructions that may be embedded in hardware or firmware in addition to, or instead of, software. In one embodiment, the device 12/server 22 may operate using an Android® operating system (such as Android® 15 or the like), an Amazon® operating system (such as FireOS or the like) or an iOS® operating system (such as iOS 18 or the like).

The user interface module 954 provides to the user the information such as playing the background component, displaying the animated component that is responsive to the user manipulation and the like. It also allows the user to control the background component playback and the background component playback, if applicable, through video controls, to accomplish recording process and various other steps of the system 10.

The recording module 956 is responsible for recording the changing animation parameters in an appropriate manner so that based on the animation parameters an animation pattern can be derived that is an exact or approximate match with original animation pattern defined by the user.

The video processing interface module 958 may be used when there is a need to transform the information contained in the animation parameters to a form suitable for video processing module 960.

The video processing module 960 is the module that processes the background component’s visual content and animation component’s visual content based on the animation parameters received from the video processing interface module 958 or directly from the recorded animation parameters and produces new video data. The video processing module 960 may use off-the-shelf video processing software/firmware/hardware with its own video filters or with custom programmed video filters or a combination thereof in order to achieve the functionality of this disclosure. The video processing module 960 may use video processing software/firmware/hardware programmed fully or partially (in conjunction with parts of other software/firmware/hardware) for the purpose and in order to achieve the functionality of this disclosure.

Executable computer instructions for operating the device 12/server 22 and its various components may be executed by the controller(s)/processor(s) 946, using the memory 948 as temporary "working" storage at runtime. The executable instructions may be stored in a non-transitory manner in non-volatile memory 948, storage 950, or an external device. Alternatively, some or all of the executable instructions may be embedded in hardware or firmware in addition to or instead of software.

The components of the device(s) 12/server 22, as illustrated in FIG. 9, are exemplary, and may be located in a stand-alone device or may be included, in whole or in part, as a component of a larger device or system.

The concepts disclosed herein may be applied within a number of different devices and computer systems, including, for example, mobile device (smart phones), tablet computers, laptop computers, general-purpose computing systems, server-client computing systems, mainframe computing systems, personal digital assistants (PDAs), video capturing devices, distributed computing environments, etc. Thus, the modules, components and/or processes described above may be combined or rearranged without departing from the scope of the present disclosure. The functionality of any module described above may be allocated among multiple modules or combined with a different module. As discussed above, any or all of the modules may be embodied in one or more general-purpose microprocessors, or in one or more special-purpose digital signal processors or other dedicated micro-processing hardware. One or more modules may also be embodied in software implemented by a processing unit. Further, one or more of the modules may be omitted from the processes entirely.

The foregoing description of the exemplary embodiment of the present invention has been presented for the purpose of illustration in accordance with the provisions of the Patent Statutes, and is provided in order to enable a person skilled in the art to make or use the present invention. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

We claim:

1. A method implemented by at least one computing device for creating animations, the method comprising:
obtaining visual content data to be used as a background component and visual content data to be used as an animated component, in any order or concurrently, and displaying the background component and the animated component on a playback device display, wherein the background component comprises any visual content, including a transparent background, against which the animated component is manipulated and in relation to which animation parameters are recorded;
playing the background component, wherein when the background component comprises static visual content, playback is achieved by artificially generated time-based progression;
simultaneously with the playing of the background component, manipulating, responsive to a first manual user input, the animated component with respect to the background component;
wherein the manipulation changes animation parameters of the animated component comprising at least one of: position; one or more dimensional parameters including scale, width scale, and height scale; skew; rotation; and parameters that control a type of a parameterized rig or blend shape animation, resulting in a plurality of the animation parameters in relation to the background component’s temporal or frame-based positions;
recording the animation parameters as defined through the user input in relation to the background component’s temporal or frame-based positions; and
newly creating a separate video from images of the background component and the animated component, such that the animated component is overlaid on the background component using animation parameters relating to the temporal or frame-based positions of the images, wherein the animation parameters are the recorded animation parameters or are derived from the recorded animation parameters.

2. The method as defined in claim 1, further comprising the step of setting a playback speed for playing the background component.

3. The method as defined in claim 1, further comprising the step of setting a temporal or frame-based position on the background component, at which position the playing of the background component and simultaneous manipulation of the animated component will be initiated.

4. The method as defined in claim 1, further comprising the step of initializing the animation parameters by manipulating, responsive to a second manual user input, the animated component in relation to the background component, prior to the playing of the background component and simultaneous manipulation of the animated component.

5. The method as defined in claim 1, wherein for each component that comprises the static visual content, the artificially generated time-based progression is achieved by at least one of:
generating a sequence of frames derived from the static visual content of the component; or
artificially generating time-based progression while displaying the static visual content of the component in a fixed state;
such that the animation parameters are recorded in relation to the generated time in the same manner as for components comprising time-based media.

6. The method as defined in claim 1, further comprising: adjusting, manually, automatically or a combination of both, the size and position of the background component to fit the display, or to any other size and position including sizes and positions that result in partial display of the background component on the display.

7. The method as defined in claim 1, wherein, when the animated component comprises time-based media, the animated component is played back simultaneously with the playing of the background component, with playback of the animated component initiated from a temporal or frame-based position within the animated component set either automatically or manually.

8. The method as defined in claim 1, further comprising the step of modifying the user input in a predetermined or user-selected way, wherein the modification takes place at a level of an input device or at a level of the recorded animation parameters, and wherein the modification includes making the user input or the recorded animation parameters smoother.

9. The method as defined in claim 1, further comprising the step of implementing an input logic for the manipulation, wherein the input logic comprises:
a definition of which animation parameters are manipulatable during the recording; and
an interpretation of how the first manual user input is translated into changes to those animation parameters;
wherein the input logic governs how the user input modifies the animation parameters during the manipulation.

10. The method as defined in claim 9, further comprising the step of establishing a plurality of parallel recording layers, wherein:
each recording layer is associated with a respective input logic;
respective animation parameters are recorded in each of the plurality of recording layers, each layer using its associated input logic; and
the animation parameters from the plurality of recording layers are superimposed to produce their combined effect on the newly created video.

11. The method as in claim 10, further comprising the step of establishing a hierarchy between the plurality of parallel recording layers that determines an order in which the animation parameters from different layers are applied when producing the newly created video, wherein the hierarchy ensures different results are achieved depending on the order in which the animation parameters from the respective layers are applied.

12. The method as in claim 1, further comprising the step of animating a plurality of animated components in relation to the background component, wherein each animated component is manipulated and the animation parameters of each animated component are independently recorded, and the newly created video has all of the animated components overlaid on the background component according to a stacking context that determines the rendering order of the animated components along a depth axis.

13. The method as in claim 12, wherein the stacking context is editable by the user, allowing the rendering order of the animated components along the depth axis to be changed.

14. The method as in claim 1, further comprising the step of animating a plurality of animated components sequentially, wherein for each subsequent animated component, the newly created video produced from a previous animated component is used as the background component.

15. The method as in claim 1, further comprising:
recording a plurality of sequences of animation parameters, wherein each sequence corresponds to a continuous recording session from when a user starts recording until the user stops recording; and
implementing a multiple sequence logic for handling the relationship between existing recording data and a new recording sequence, wherein:
the existing recording data comprises animation parameters already defined for portions of the background component’s temporal or frame-based positions, either from a single previous recording sequence or as a result of multiple previous recording sequences combined according to the multiple sequence logic; and
the new recording sequence is a recording sequence created by the user after the existing recording data has been established;
wherein the multiple sequence logic determines how the new recording sequence interacts with and modifies the existing recording data; and
wherein the multiple sequence logic comprises at least one of:
keeping the existing recording data for portions of the background component preceding the starting temporal or frame-based position of the new recording sequence and replacing the existing recording data with the new recording sequence for portions succeeding that position;
keeping the existing recording data for portions preceding the starting position of the new recording sequence, replacing the existing recording data with the new recording sequence for portions where both overlap, and keeping the existing recording data for portions succeeding the ending position of the new recording sequence; or
interpolating animation parameters for the temporal or frame-based positions of the background component that fall between the temporally adjacent but non-contiguous portions of the existing recording data and the new recording sequence, wherein the interpolated animation parameters, whether stored as recording data or calculated at the time of video production, are used when overlaying the animated component on the background component for those positions in the newly created video.

16. The method as in claim 1, wherein for the temporal or frame-based positions of the background component where no animation parameters have been recorded, animation parameters for those positions, whether stored as recording data or calculated at the time of video production, are derived by applying the same values as the animation parameters of the nearest temporal or frame-based position for which a recording exists, and are used when overlaying the animated component on the background component for those positions in the newly created video.

17. The method as in claim 1, wherein newly creating the separate video occurs at one or more of:
after completion of recording all the animation parameters;
during an ongoing continuous recording session after some but not all animation parameters have been recorded, or between continuous recording sessions when multiple continuous recording sessions are performed, wherein a continuous recording session corresponds to a period from when a user starts recording until the user stops recording; or
in real-time during user input immediately after recording individual animation parameters;
wherein the new video is produced either as a single continuous sequence or as a series of smaller video sequences that can be separately processed and subsequently joined together.

18. The method as in claim 1, further comprising: initializing the animation parameters automatically using a content recognition method applied to the background component, wherein the content recognition method identifies a visual feature in the background component and sets the initial animation parameters to correspond to the identified visual feature, to aid subsequent manipulation of the animated component in relation to the identified visual feature.

19. The method as in claim 1, further comprising: automatically generating animation parameters for the temporal or frame-based positions of the background component using a content recognition and tracking method applied to the background component; and recording one or more manual recording sequences responsive to the first manual user input, wherein the manual recording sequences supplement or override the automatically generated animation parameters for one or more of the temporal or frame-based positions of the background component.

20. A system, implemented by at least one computing device, for creating animations, the system comprising:
a user interface comprising:
a display for obtaining and displaying a background component and an animated component, in any order or concurrently, wherein the background component comprises any visual content including a transparent background, and wherein the display is capable of playing the background component, including by artificially generated time-based progression when the background component comprises static visual content; and
one or more user input devices capable of accepting manual user input;
wherein the display and at least one of the one or more user input devices may be integrated into a single physical device or may be implemented as separate physical devices;
a first processing component configured to enable, simultaneously with the playing of the background component, manipulating the animated component with respect to the background component, responsive to a first manual user input;
wherein the manipulation changes animation parameters of the animated component comprising at least one of: position; one or more dimensional parameters including scale, width scale, and height scale; skew; rotation; and parameters that control a type of a parameterized rig or blend shape animation, resulting in a plurality of the animation parameters in relation to the background component’s temporal or frame-based positions;
an electronic memory connected to the first processing component for recording the animation parameters as defined through the user input in relation to the background component’s temporal or frame-based positions; and
a second processing component configured to newly create and store a separate video from images of the background component and the animated component, such that the animated component is overlaid on the background component using animation parameters relating to the temporal or frame-based positions of the images, wherein the animation parameters are the recorded animation parameters or are derived from the recorded animation parameters;
wherein the first processing component and the second processing component are configured to be implemented using at least one of: a common processing resource, separate processing resources, hardware elements, software elements, or combinations thereof.
